(19) United States
(12) Patent Application Publication
(10) Pub. No.: US 2010/0202688 A1
(43) Pub. Date: Aug. 12, 2010

(54) DEVICE FOR SEGMENTING AN OBJECT IN AN IMAGE, VIDEO SURVEILLANCE SYSTEM, METHOD AND COMPUTER PROGRAM

(76) Inventors: Jie Yu, Hildesheim (DE); Julia Ebling, Hildesheim (DE); Hartmut Loos, Hildesheim (DE)

Correspondence Address: MICHAEL J. STRIKER, 103 EAST NECK ROAD, HUNTINGTON, NY, 11743, US

(21) Appl. No.: 12/694,824

(22) Filed: Jan. 27, 2010

(30) Foreign Application Priority Data
Feb. 12, 2009 (DE) 10 2009 000 810.1

(51) Int. Cl. G06K 9/34; H04N 7/18

(52) U.S. Cl. 382/173; 348/143

(57) ABSTRACT

A device for segmenting an object in an image, in which a surveillance region containing one or more objects is depicted or depictable in image, has an estimating module which is designed to estimate a distance in the surveillance region based on a possible object pixel of object in image, a segmenting module which is designed to segment object containing object pixel according to a segmentation strategy, and a strategy module which is programmed and/or electronically configured to adapt the segmentation strategy to object depending on the estimated distance.

### CROSS-REFERENCE TO A RELATED APPLICATION

The invention described and claimed hereinbelow is also described in German Patent Application DE 10 2009 000 810.1 filed on Feb. 12, 2009. This German Patent Application, whose subject matter is incorporated here by reference, provides the basis for a claim of priority of invention under 35 U.S.C. 119(a)-(d).

### BACKGROUND OF THE INVENTION

The present invention relates to a device for segmenting an object in an image, in which a surveillance region containing one or more objects is depicted and/or depictable in the image, comprising an estimating module which is designed to estimate a distance in the surveillance region based on a possible object pixel of the object in the image, and comprising a segmenting module which is designed to segment the object containing the object pixel according to a segmentation strategy. The present invention also relates to a video surveillance system, a method for segmenting an object in an image, and a computer program.

Video surveillance systems are often used today to monitor public places and buildings or commercial establishments, and include one or more surveillance cameras which are directed toward relevant regions of a surveillance region. The image data streams generated by the surveillance cameras are typically transmitted to a monitoring center, where they may be examined, e.g., immediately, by surveillance personnel.

To improve the quality of surveillance, image processing algorithms are used to evaluate the image data streams in an automated manner. In many applications, moving objects in the surveillance region are separated from the (substantially static) background and tracked over time, and, if relevant movements are observed, an alarm is triggered. The image processing algorithms are often based on evaluating the differences between an actual camera image and a scene reference image which is a model of the static scene background. Starting with the actual camera image, this method yields a large number of differential pixels which, in a subsequent step, are segmented to form an object which may then be processed further, e.g., in further images.

DE 199 326 62 A1, for example, relates to a method for detecting scene changes, and to a surveillance device therefor, and represents the closest prior art. In this publication, a method is proposed for detecting changes in a field of view observed by a stationary image acquisition unit, in which edge images are observed and are compared to edge images of reference images in order to detect static changes within the region that was observed that are independent of image brightness.

### SUMMARY OF THE INVENTION

Accordingly, it is an object of the present invention to provide a device, a video surveillance system, a method and a computer program for segmenting an object in an image, which is a further improvement of the corresponding solutions.

In keeping with these objects and with others which will become apparent hereinafter, one feature of the present invention resides, briefly stated, in a device for segmenting an object in an image, in a case of which a surveillance region containing one or more objects is depicted in the image, the device comprising an estimating module estimating a distance in the surveillance region based on a possible object pixel of the object in the image; a segmenting module segmenting the object that contains the object pixel according to a segmentation strategy; and a strategy module selected from the group consisting of a programmed strategy module, an electronically configured strategy module, and a programmed and electronically configured strategy module adopting the segmentation strategy for the object depending on the estimated distance.

Another feature of the present invention resides, briefly stated, in a video surveillance system, comprising at least one surveillance camera; and the device for segmenting an object in an image in accordance with the invention.

A further feature of the present invention resides in a method for segmenting an object in an image, comprising the steps of depicting a surveillance region with one or more objects in the image; estimating a distance to the object or a subregion thereof in the surveillance region; and selecting and/or modifying a segmentation strategy depending on the estimated distance.

Still a future feature of the present invention resides, briefly stated, in a computer program comprising program code means for carrying out all steps of the method in accordance with the invention, when the program is run on a computer.

A device for segmenting an object in an image, in particular in a video image, is presented, in the case of which a real surveillance region containing one or more objects is depicted or depictable in the image. The image is preferably obtained from a surveillance camera which is directed and/or directable toward the surveillance region or a region in the surveillance region. The image may also be a portion of a video sequence.

“Segmenting” preferably refers to combining pixels that are adjacent and/or close to one another in particular, that is, pixels that are less than 10 pixels and, preferably, less than 5 pixels away from a region that is cohesive in terms of content in particular, the region representing one of the objects in the surveillance region.

In one possible embodiment, pixels, in particular differential pixels, which were identified as being relevant in a pre-processing step in which the differences between an actual image and a reference image, in particular a scene reference image, are identified—are segmented to form one or more objects.

The device includes an estimating module which is designed to estimate a real distance, in the surveillance region, of a possible object pixel of the object in the image.

The possible object pixel may be selected using specifiable rules; in particular, the object pixel is one of the above-described relevant pixels or differential pixels.

Furthermore, the device includes a segmenting module which segments the object according to a segmentation strategy, the object containing the object pixel, the distance to which was previously estimated. The segmentation strategy relates to rules regarding the segmentation method.

According to the present invention, a strategy module is provided, which is programmed and/or electronically configured to adapt the segmentation strategy to the object depending on the estimated distance of the object pixel.

Using knowledge of the scene, the distance of the object pixel is estimated first, and, in many embodiments, the distance of the object is estimated next, that is, e.g., the distance between the camera capturing the image and the object itself; the segmentation strategy is adapted depending on the estimated distance. The advantage of the present invention is that, e.g., knowledge of the scene is used as support to segment the objects in the image, and so additional knowledge is incorporated in the image processing. As a result, segmentation may be performed in a more robust manner and yield better results.

In a preferred embodiment of the present invention, the strategy module may access at least two different segmentation strategies. The segmentation strategies may differ in terms of the selection or the combination or weighting of segmentation methods. It is possible, e.g., to select any combination of pixel-oriented, edge-oriented, region-oriented, model-based, texture-based, and/or color-oriented methods. In pixel-oriented methods, criteria for object assignment are only related to the current pixel. In edge-oriented methods, a search is carried out for edges and/or contours that are combined to form object boundaries. In region-oriented methods, cohesive groups of points are considered in entirety. Model-based methods utilize specific knowledge of the objects. In texture-oriented methods, segmenting is carried out based on a texture, in particular a homogeneous or inhomogeneous inner structure of the object, rather than based on a uniform color. It is also possible to use color-oriented methods which segment an object according to color association. For example, it is also possible for the segmentation strategies to differ according to the use of shadow detection.

As an alternative or in addition thereto, the segmentation strategies may differ according to the parameterization of the different methods, e.g., different limit values, etc., may be used.

In a simple embodiment of the present invention, the strategy module includes at least a first segmentation strategy which is applied to nearby objects, and a second segmentation strategy which is applied to distant objects. The estimated distance of the object pixel of a nearby object is less than the estimated distance of the object pixel of a distant object.

In one possible embodiment of the present invention, the estimating module is designed to estimate the distance depending on the position of the object pixel in the image. This embodiment makes use of the fact that—e.g., when a flat surface such as a parking lot is being monitored—pixels in the lower image regions belong to objects having a shorter distance than do pixels in the upper image regions, since it is assumed that all objects move on the flat surface. It is therefore particularly preferable for the object pixel to be a foot pixel of the object, i.e., a pixel located in the lower edge region of the object, since this edge region represents the contact zone with the background. In one implementation of the present invention, it is feasible for the lower image regions to be examined first, row-by-row, for relevant pixels which are then processed further as object pixels.

In other possible embodiments of the present invention, the camera may be calibrated to generate the image, in which case it is known via the calibration how far away the real object of an object pixel is from the camera, thereby making it possible to read out a distant directly.

In one development of the present invention, it is provided that the segmenting module is designed to examine pixels adjacent to, and in particular, directly adjacent to the object pixel to determine if they belong to the same object, based on the segmentation strategy. This procedure is also known in the literature as “region growing”. The object pixel is a seed of a starting region, and adjacent pixels are added to the object when the rules of the segmentation strategy are met.

In an advantageous development of the present invention, the segmenting module may be designed such that, in a subsequent step after an initial or completed segmentation of the object, the segmented object is examined in terms of distance. For example, distance is determined once more depending on the size and other properties of the segmented object, in order to refine the segmenting based on the new distance. As an option, the examination may be carried out several times. In the subsequent segmentation, the segmentation strategy is used that is adapted to the updated distance. The advantage of this iteration is that incorrect estimates of distance which arise, e.g., due to objects being located on a ladder, or objects that jump or fly, or the like, may be corrected, thereby making it possible to improve the result of the segmentation.

A further subject of the present invention relates to a video surveillance system comprising one or more surveillance cameras which are directed and/or directable toward regions in the surveillance region in which moving objects may be present; the video surveillance system is a device of the type described above, or as recited in one of the preceding claims. The further subject matter relates to the integration of the device, according to the present invention, in a video surveillance system which is preferably designed to detect, monitor, and/or track moving objects in the surveillance region. For example, video surveillance systems of this type—as mentioned initially—are used to monitor public places and buildings, commercial establishments, or other places, such as libraries, schools, universities, prisons, etc.

Further features, advantages, and effects of the present invention result from the description that follows of a preferred embodiment of the present invention, and from the attached figures.

### BRIEF DESCRIPTION OF THE DRAWINGS

FIG. 1 shows a block diagram of a video surveillance system, as an embodiment of the present invention;

FIGS. 2 a-d show intermediate results of the processing of an image captured by the video surveillance system, to illustrate the method according to the present invention.

### DESCRIPTION OF THE PREFERRED EMBODIMENTS

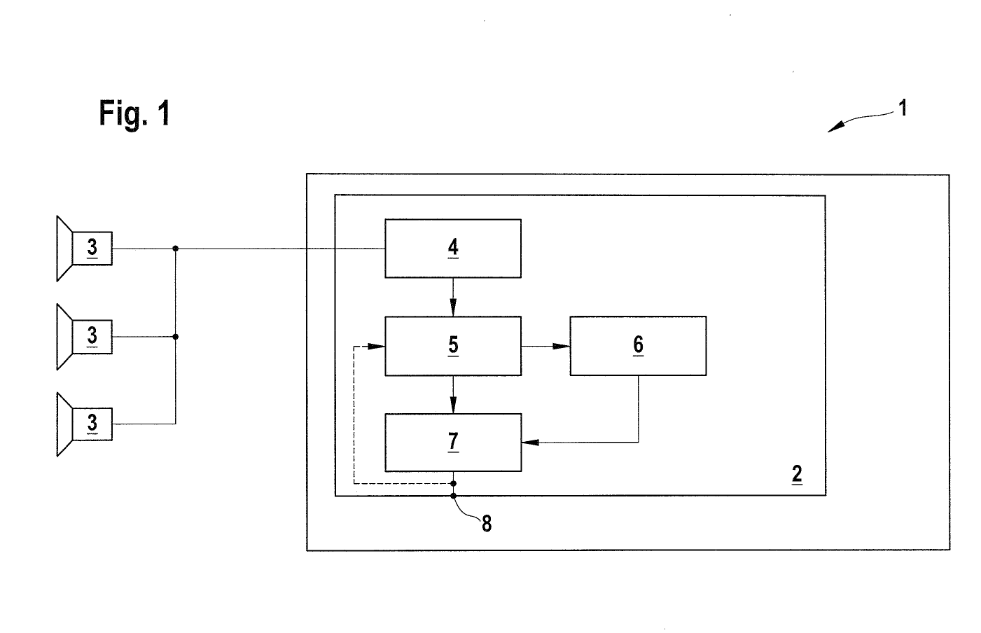

FIG. 1 shows a schematic block diagram of a video surveillance system 1 which includes a segmenting device 2 in addition to optional, further components which are not depicted. Video surveillance system 1 is connected to one or more surveillance cameras 3 which are directed toward a surveillance region in which moving objects may be present. Video surveillance system 1 is used, e.g., to monitor a street, and is used in general to detect, recognize, and/or track moving objects. The moving objects are, e.g., persons or vehicles.

Actual video images of the surveillance region are transferred from surveillance cameras 3 to video surveillance system 1. In a first step carried out in a search module 4, relevant pixels in one of the video images that (may) belong to a moving object are identified. For this purpose, e.g., the current video image is extracted from a scene reference image that shows the static or quasi-static objects or regions in the surveillance region, and the remaining pixels above a specifiable limit value are interpreted as being relevant pixels. The relevant pixels represent the changes that have occurred in the current video image compared to the scene reference image. As an alternative, other methods may be used to identify the relevant pixels.

In an estimating module 5, a real distance in the surveillance region is estimated for at least one of the relevant pixels, which is referred to below as an object pixel of an object. The distance may be based, e.g., on the position of surveillance camera 3 that is recording the video image, or on another reference position.

The value of the estimated distance is transmitted to a strategy module 6 which provides and/or modifies a segmentation strategy for the object belonging to the object pixel depending on the value of the estimated distance. For example, a segmentation strategy for an object located in close proximity to surveillance camera 3 may utilize the following criteria:
Texture information on the object, and/or
The filling-in of enclosed, homogeneous regions, and/or
Color information, if present
Color-dependent segmentation of homogeneous areas
Shadow detection
and/or
Less sensitive segmentation, since large and clearly recognizable objects are expected, and/or
Removing objects that are too small, i.e., objects that are smaller than a minimum size.

The following criteria for a segmentation strategy may be used in a region located further away:
More sensitive segmenting than in the nearby region, to avoid overlooking objects, and/or
Texture information.

The segmentation strategy and the pre-processed image data containing the relevant pixels are transmitted to a segmenting module 7 which uses the relevant pixels to segment an object contained therein, by applying the segmentation strategy and starting with the object pixel.

In a simple embodiment, the segmented object is output via an output 8 for further processing.

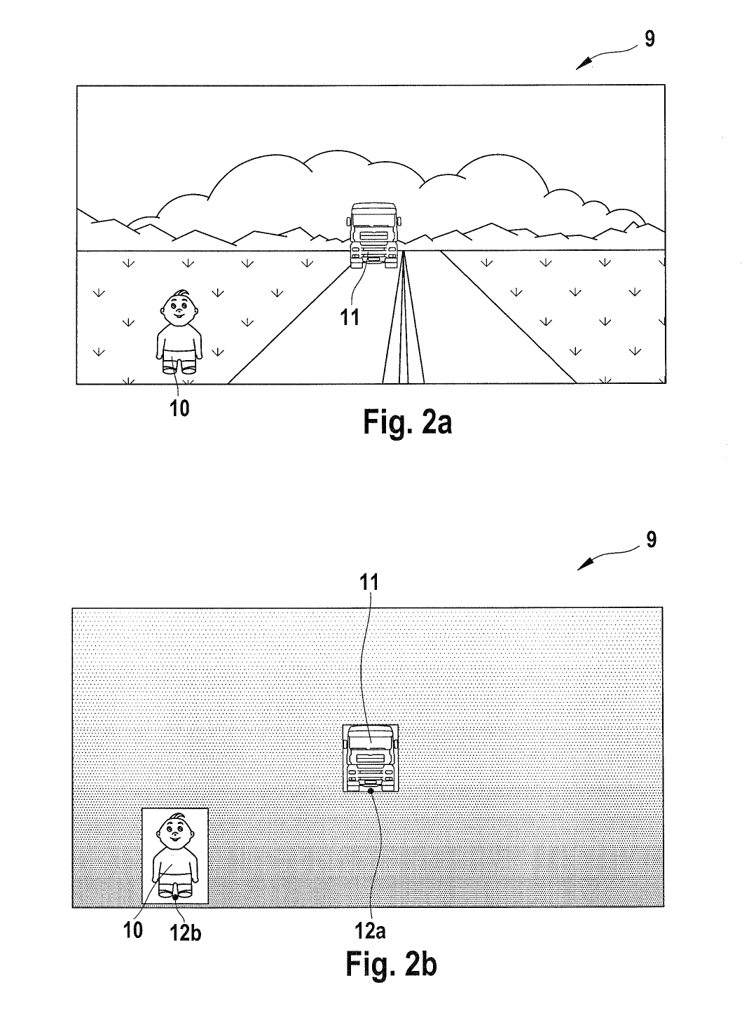

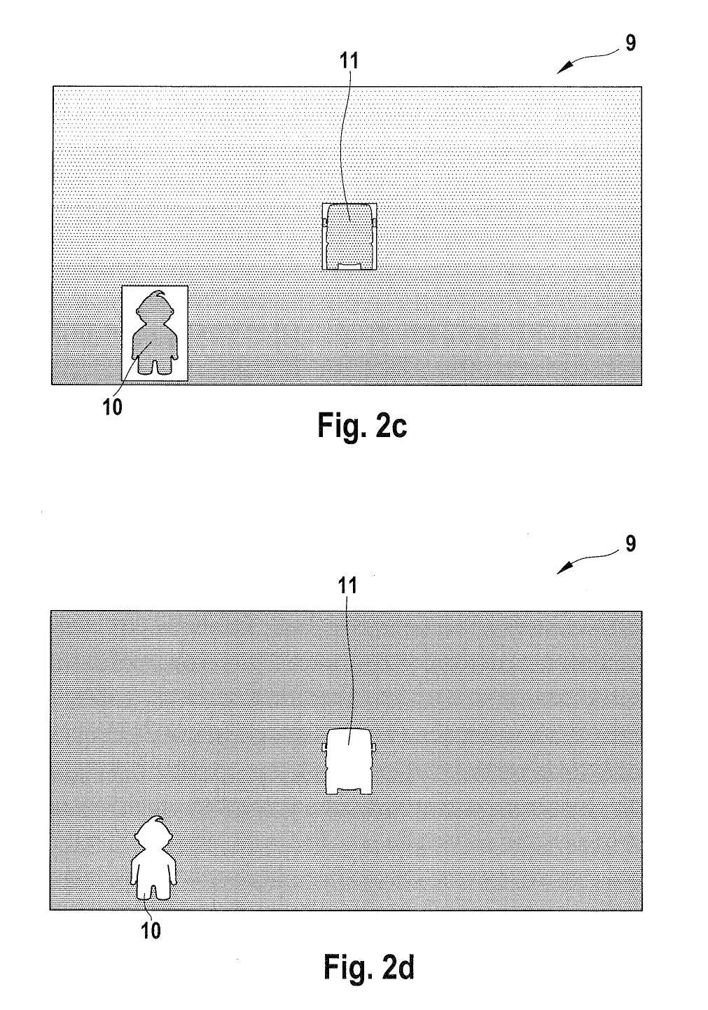

FIGS. 2 a through d illustrate, once more, the above-described steps of a segmenting method that forms an embodiment of the present invention. FIG. 2a shows a highly schematicized image 9 of a surveillance region, which is real in this case, in the form of a street, and in which a child 10 and a truck 11, as the moving objects, are present.

In the pre-processing carried out using search module 4, image 9 in FIG. 2a is first compared to a scene reference image that shows the surveillance region as a static background. The elements common to image 9 and the scene reference image are eliminated as static elements in image 9, and so the street, horizon, etc., are filtered out. FIG. 2b shows the result of this pre-processing; after the static regions are eliminated, only the image regions of child 10 and truck 11 remain.

These regions are regions containing pixels that are relevant for further processing. Next, in estimating module 5, the actual distance in the surveillance region is estimated for one of the relevant pixels, as the object pixel, in the regions of the moving objects, i.e., child 10 and truck 11 in this example. In particular, foot points 12 a, b of the moving objects are used as object pixels. Foot points 12 a, b may be found, e.g., by using “bounding boxes”, i.e., enclosing rectangles, of collections of relevant pixels. As an alternative, foot points 12 a, b may also be located by searching the lowermost rows of pre-processed image 9.

To estimate the distance, use is made of the fact—as indicated in FIG. 2b via graytones—that objects in image 9 located far away from associated surveillance camera 3 have a foot point 12a that is located higher in image 9 than do objects located closer to camera 3, having foot point 12b. As an alternative to this procedure, the distance of object pixels may also be estimated by calibrating surveillance cameras 3, or by using other methods.

FIG. 2c illustrates how, starting with foot points 12 a, b, further relevant pixels of particular object 10, 11 are combined to form one common pixel cloud. Since it may be assumed that all pixels of object 10 or 11 are located at the same distance in the surveillance region as the associated object pixel, the same distance is assigned to all pixels in the common pixel cloud. In other words, the distance information is transported along object 10, 11, starting at foot point 12 a, b.

FIG. 2d depicts schematically how segmentation module 7 segments the pixel clouds into objects or object masks, in which case, based on the distance information, an optimal or optimized segmentation strategy is calculated and provided by strategy model 6.

In one amendment, it is possible that, after an initial segmentation is carried out by segmenting module 7, the estimated distance is checked depending, e.g., on the size and other properties of object 10, 11, and it is corrected as necessary; after a correction is carried out, the segmenting procedure is repeated in segmenting module 7, and it is optionally carried out using a segmentation strategy that is adapted to the new distance, in order to refine the segmentation. Using this procedure, it is possible to correct incorrect estimates of distance, e.g., due to objects being located on a ladder, or objects that jump or fly, or the like, and segmenting may be refined. This iteration is indicated in FIG. 1 by a dashed arrow.

It will be understood that each of the elements described above, or two or more together, may also find a useful application in other types of constructions and methods differing from the types described above.

While the invention has been illustrated and described as embodied in a device for segmenting an object in an image, video surveillance system, method and computer program, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for segmenting an object in an image, in a case of which a surveillance region containing one or more objects is depicted in the image, the device comprising an estimating module estimating a distance in the surveillance region based on a possible object pixel of the object in the image; a segmenting module segmenting the object that contains the object pixel according to a segmentation strategy; and a strategy module selected from the group consisting of a programmed strategy module, an electronically configured strategy module, and a programmed and electronically configured strategy module and adopting the segmentation strategy for the object depending on the estimated distance.

2. A device for segmenting an object of an image as defined in claim 1, wherein said strategy module includes at least two different segmentation strategies.

3. A device for segmenting an object of an image as defined in claim 2, wherein said strategy module includes the at least two different segmentation strategies including a first segmentation strategy adapted to nearby objects and a second segmentation strategy adapted to distant objects.

4. A device for segmenting an object of an image as defined in claim 2, wherein said strategy module includes the segmentation strategies which differ in terms of an evaluation of any of the following features:
size of the objects and/or subregions thereof,
color of the objects and/or subregions thereof,
textures of the objects and/or subregions thereof.

5. A device for segmenting an object of an image as defined in claim 2, wherein said strategy module includes the at least two different segmentation strategies which differ in terms of shadow detection.

6. A device for segmenting an object of an image as defined in claim 1, wherein said estimating module estimates the distance depending on a position of the object pixel in the image.

7. A device for segmenting an object of an image as defined in claim 1, wherein said estimating module estimates a distance in the surveillance region based on the possible object pixel of the object, and said segmenting module segments the object that contains the object pixel, which object pixel is a foot pixel of the object.

8. A device for segmenting an object of an image as defined in claim 1, wherein said segmenting module examines pixels adjacent to the object pixel to determine if they belong to a same object, based on the segmentation strategy.

9. A device for segmenting an object of an image as defined in claim 8, wherein said segmenting module examines pixels directly adjacent to the object pixel.

10. A device for segmenting an object of an image as defined in claim 1, wherein said segmenting module examines the segmented object in terms of distance.

11. A video surveillance system, comprising at least one surveillance camera; and a device for segmenting an object in an image as defined in claim 1.

12. A video surveillance system as defined in claim 11, wherein the video surveillance system has a plurality of the surveillance cameras.

13. A method for segmenting an object in an image, comprising the steps of depicting a surveillance region with one or more objects in the image; estimating a distance to the object or a subregion thereof in the surveillance region; and selecting and/or modifying a segmentation strategy depending on the estimated distance.

14. A method as defined in claim 13, wherein the method for segmenting an object in an image is carried out on the device defined in claim 1.

15. A method as defined in claim 13, wherein the method for segmenting an object in an image is carried out on a video surveillance system defined in claim 11.

16. A computer program comprising program code means for carrying out all steps of the method as defined in claim 13, when the program is run on a computer.

17. A computer program comprising program code means for carrying out all steps of the method as defined in claim 13, when the program is run on the device defined in claim 1.

18. A computer program comprising program code means for carrying out all steps of the method as defined in claim 13, when the program is run on the video surveillance system as defined in claim 11.
